(19) United States
(12) Patent Application Publication
(10) Pub. No.: US 2013/0101164 A1
(43) Pub. Date: Apr. 25, 2013

(54) METHOD OF REAL-TIME CROPPING OF A REAL ENTITY RECORDED IN A VIDEO SEQUENCE

(71) Applicants: Brice Leclerc, Nozay (FR); Olivier Marce, Nozay (FR); Yann Leprovost, Nozay (FR)

(72) Inventors: Brice Leclerc, Nozay (FR); Olivier Marce, Nozay (FR); Yann Leprovost, Nozay (FR)

(73) Assignee: ALCATEL LUCENT, Paris (FR)

(21) Appl. No.: 13/638,832

(22) PCT Filed: Apr. 1, 2011
(86) PCT No.: PCT/FR11/50734

§ 371 Date: Dec. 17, 2012

(30) Foreign Application Priority Data
Apr. 6, 2010 (FR) 1052567

(51) Int. Cl. G06T 11/60; G06T 19/20

(52) U.S. Cl. CPC G06T 11/60; G06T 19/20
USPC 382/103

(57) ABSTRACT

A method of real-time cropping of a real entity in motion in a real environment and recorded in a video sequence, the real entity being associated with a virtual entity, the method comprising the following steps: extraction (S1, S1A) from the video sequence of an image comprising the real entity recorded, determination of a scale and/or of an orientation (S2, S2A) of the real entity on the basis of the image comprising the real entity recorded, transformation (S3, S4, S3A, S4A) suitable for scaling, orienting, and positioning in a substantially identical manner the virtual entity and the real entity to recorded, and substitution (S5, S6, S5A, S6A) of the virtual entity with a cropped image of the real entity, the cropped image of the real entity being a zone of the image comprising the real entity recorded delimited by a contour of the virtual entity.

### FIELD OF THE INVENTION

One aspect of the invention concerns a method for cropping, in real time, a real entity recorded in a video sequence, and more particularly the real-time cropping of a part of a user's body in a video sequence, using an avatar's corresponding body part. Such a method may particularly but not exclusively be applied in the field of virtual reality, in particular animating an avatar in a so-called virtual environment or mixed-reality environment.

### STATE OF THE PRIOR ART

FIG. 1 represents an example virtual reality application within the context of a multimedia system, for example a videoconferencing or online gaming system. The multimedia system 1 comprises multiple multimedia devices 3, 12, 14, 16 connected to a telecommunication network 9 that makes it possible to transmit data, and a remote application server 10. In such a multimedia system 1, the users 2, 11, 13, 15 of the respective multimedia devices 3, 12, 14, 16 may interact in a virtual environment or in a mixed reality environment 20 (depicted in FIG. 2). The remote application server 10 may manage the virtual or mixed reality environment 20. Typically, the multimedia device 3 comprises a processor 4, a memory 5, a connection module 6 to the telecommunication network 9, means of display and interaction 7, and a camera 8, for example a webcam. The other multimedia devices 12, 14, 16 are equivalent to the multimedia device 3 and will not be described in greater detail.

FIG. 2 depicts a virtual or mixed reality environment 20 in which an avatar 21 evolves. The virtual or mixed reality environment 20 is a graphical representation imitating a world in which the users 2, 11, 13, 15 can evolve, interact, and/or work, etc. In the virtual or mixed reality environment 20, each user 2, 11, 13, 15 is represented by his or her avatar 21, meaning a virtual graphical representation of a human being. In the aforementioned application, it is beneficial to mix the avatar's head 22, in real-time, with a video of the head of the user 2, 11, 13 or 15 taken by the camera 8, or in other words to substitute the head of the user 2, 11, 13 or 15 for the head 22 of the corresponding avatar 21 dynamically or in real time. Here, dynamic or in real-time means synchronously or quasi-synchronously reproducing the movements, postures, and actual appearances of the head of the user 2, 11, 13 or 15 in front of his or her multimedia device 3, 12, 14, 16 on the head 22 of the avatar 21. Here, video refers to a visual or audiovisual sequence comprising a sequence of images.

The document US 20091202114 describes a video capture method implemented by a computer comprising the identification and tracking of a face within a plurality of video frames in real time on a first computing device, the generating of data representative of the identified and tracked face, and the transmission of the face's data to a second computing device by means of a network in order for the second computing device to display. the face on an avatar's body.

The document by SONOU LEE et al: “CFBOXTM: superimposing 3D human face on motion picture”, PROCEEDINGS OF THE SEVENTH INTERNATIONAL CONFERENCE ON VIRTUAL SYSTEMS AND MULTIMEDIA BERKELEY, Calif., USA Oct. 25-27, 2001, LOS ALAMITOS, Calif., USA, IEEE COMPUT. SOC, US LNKD D01:10.1109NSMM.2001.969723, Oct. 25, 2001 (2001-10-25), pages 644-651, XP01567131 ISBN: 978-0-7695-1402-4 describes a product named CFBOX which constitutes a sort of personal commercial film studio. It replaces the person's face with that of a user's modeled face, using, in real-time, a three-dimensional face integration technology. It also proposes manipulation features for changing the modeled face's texture to suit one's tastes. It therefore enables the creation of custom digital video.

However, cropping the head from the video of the user captured by the camera at a given moment, extracting it, then pasting onto the avatar's head and repeating the sequence at later moments is a difficult and expensive operation, because real rendering is sought out. First, contour recognition algorithms require a high-contrast video image. This may be obtained in a studio with ad hoc lighting. On the other hand, this is not always possible with a webcam and/or in the lighting environment of a room in a home or office building. Additionally, contour recognition algorithms require heavy computing power from the processor. Generally speaking, this much computing power is not currently available on standard multimedia devices such as personal computers, laptop computers, personal digital assistants (PDAs), or smartphones.

Consequently, there is a need for a method to crop a part of a user's body in a video in real time, using the corresponding part of an avatar's body with a high enough quality to afford a feeling of immersion in the virtual environment and which may be implemented with the aforementioned standard multimedia devices.

### DESCRIPTION OF THE INVENTION

One purpose o the invention is to propose a method for cropping an area of a video in real time, and more particularly cropping a part of a user's body in a video in real time by using the corresponding part of an avatar's body intended to reproduce an appearance of the user's body part, and the method comprises the steps of:
extracting from the video sequence an image comprising the user's recorded body part,
determining an orientation and scale of the user's body part within the image comprising the user's recorded body part,
orienting and scaling the avatar's body part in a manner roughly identical to that of the user's body part, and
using a contour of the avatar's body part to form a cropped image of the image comprising the user's recorded body part, the cropped image being limited to an area of the image comprising the user's recorded body part contained within the contour.

According to another embodiment of the invention, the real entity may be a user's body part, and the virtual entity may be the corresponding part of an avatar's body that is intended to reproduce an appearance of the user's body part, and the method comprises the steps of:
extracting from the video sequence an image comprising the user's recorded body part,
determining an orientation of the user's body part from the image comprising the user's body part,
orienting the avatar's body part in a manner roughly identical to that of the image comprising the user's recorded body part,
translating and scaling the image comprising the user's recorded body part in order to align it with the avatar's corresponding oriented body part,
drawing an image of the virtual environment in which a cropped area bounded by a contour of the avatar's oriented body part is coded by an absence of pixels or transparent pixels; and
superimposing the virtual environment's image onto the image comprising the user's translated and scaled body part.

The step of determining the orientation and/or scale of the image comprising the user's recorded body part may be carried out by a head tracker function applied to said image.

The steps of orienting and scaling, extracting the contour, and merging may take into account noteworthy points or areas of the avatar's or user's body part.

The avatar's body part may be a three-dimensional representation of said avatar body part.

The cropping method may further comprise an initialization step consisting of modeling the three-dimensional representation of the avatar's body part in accordance with the user's body part whose appearance must be reproduced.

The body part may be the user's or avatar's head.

According to another aspect, the invention pertains to a multimedia system comprising a processor implementing the inventive cropping method.

According to yet another aspect, the invention pertains to a computer program product intended to be loaded within a memory of a multimedia system, the computer program product comprising portions of software code implementing the inventive cropping method whenever the program is run by a processor of the multimedia system.

The invention makes it possible to effectively crop areas representing an entity within a video sequence. The invention also makes it possible to merge an avatar and a video sequence in real time, with sufficient quality to afford a feeling of immersion in a virtual environment. The inventive method consumes few processor resources, and uses functions that are generally encoded into graphics cards. It may therefore be implement it with standard multimedia devices such as personal computers, laptop computers, personal digital assistants, or smartphones. It may use low-contrast images or images with defects that come from webcams.

Other advantages will become clear from the detailed description of the invention that follows.

### BRIEF DESCRIPTION OF FIGURES

The present invention is depicted by nonlimiting examples in the attached Figures, in which identical references indicate similar elements:

FIG. 2 depicts a virtual or mixed reality environment in which an avatar evolves;

FIGS. 3A and 3B are a functional diagram illustrating one embodiment of the inventive method for the real-time cropping of a user's head recorded in a video sequence; and

FIGS. 4A and 4B are a functional diagram illustrating another embodiment of the inventive method for the real-time cropping of a user's head recorded in a video sequence.

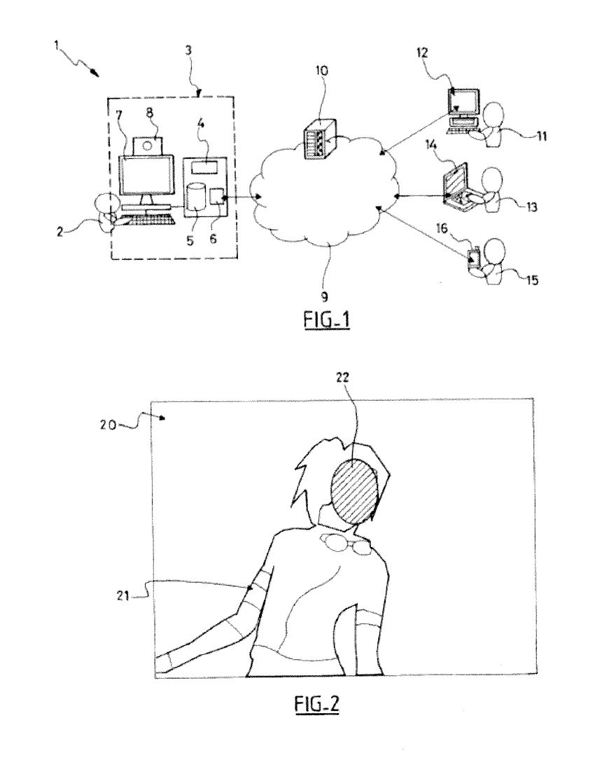

### DETAILED DESCRIPTION OF THE INVENTION

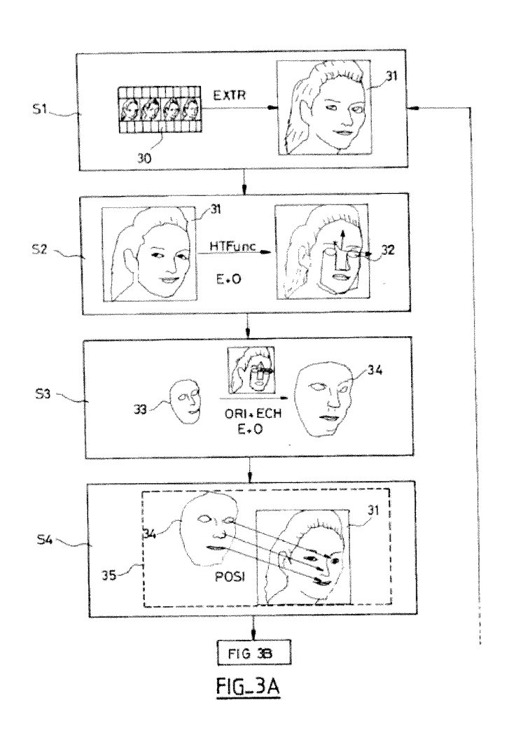

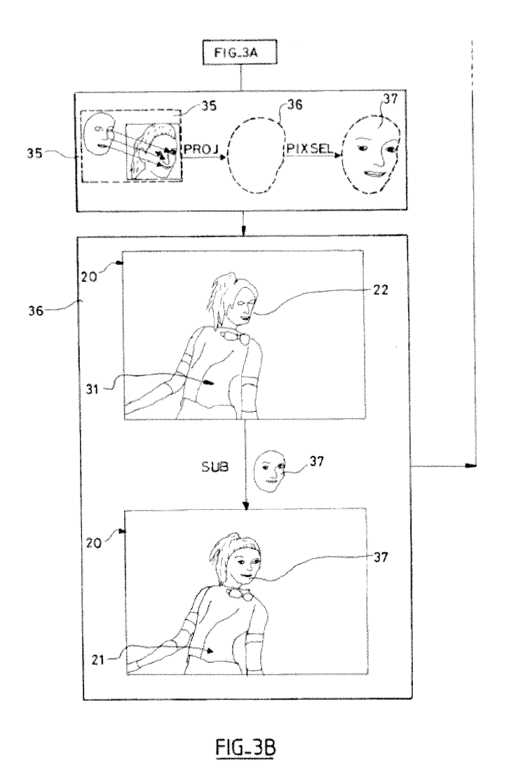

FIGS. 3A and 3B are a functional diagram illustrating one embodiment of the inventive method for the real-time cropping of a user's head recorded in a video sequence.

During a first step S1, at a given moment an image 31 is extracted EXTR from the user's video sequence 30. Video sequence refers to a succession of images recorded, for example, by the camera (see FIG. 1).

During a second step S2, a head tracker function HTFunc is applied to the extracted image 31. The head tracker function makes it possible to determine the scale E and orientation O of the user's head. It uses the noteworthy position of certain points or areas of the face 32, for example the eyes, eyebrows, nose, cheeks, and chin. Such a head tracker function may be implemented by the software application “faceAPI” sold by the company Seeing Machines.

During a third step S3, a three-dimensional avatar head 33 is oriented ORI and scaled ECH in a manner roughly identical to that of the extracted image's head, based on the determined orientation O and scale E. The result is a three-dimensional avatar head 34 whose size and orientation comply with the image of the extracted head 31. This step uses standard rotating and scaling algorithms.

During a fourth step S4, the three-dimensional avatar head 34 whose size and orientation comply with the image of the extracted head is positioned ROSI like the head in the extracted image 31. The result is that the two heads are identically positioned compared to the image. This step uses standard translation functions, with the translations taking into account noteworthy points or areas of the face, such as eyes, eyebrows, nose, cheeks, and/or chin as well as noteworthy points encoded for the avatar's head.

During the fifth step S5, the positioned three-dimensional avatar head 35 is projected PROJ onto a plane. A projection function on a standard plan, for example a transformation matrix, may be used. Next, only the pixels from the extracted image 31 that are located within the contour 36 of the projected three-dimensional avatar head are selected PIX SEL and saved. A standard function ET may be used. This selection of pixels forming a cropped head image 37; a function of the avatar's projected head and the image resulting from the video sequence at the given moment.

During a sixth step S6, the cropped head image 37 may be positioned, applied, and substituted SUB for the head 22 of the avatar 21 evolving within the virtual or mixed reality environment 20. This way, the avatar features, within the virtual environment or mixed reality environment, the actual head of the user in front of his or her multimedia device, at roughly the same given moment. According to this embodiment, as the cropped head image is pasted onto the avatar's head, the avatar's elements, for example its hair, are covered by the cropped head image 37.

As an alternative, the step S6 may be considered optional when the cropping method is used to filter a video sequence and extracts only the user's face from it. In this case, no image of a virtual environment or mixed-reality environment is displayed.

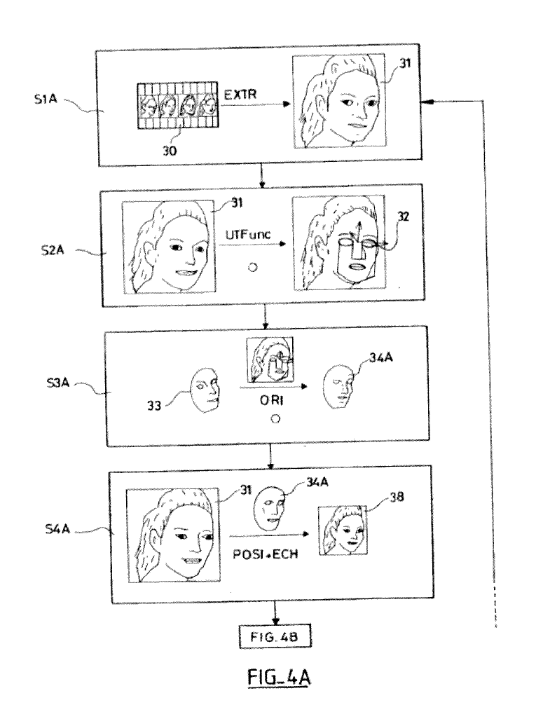

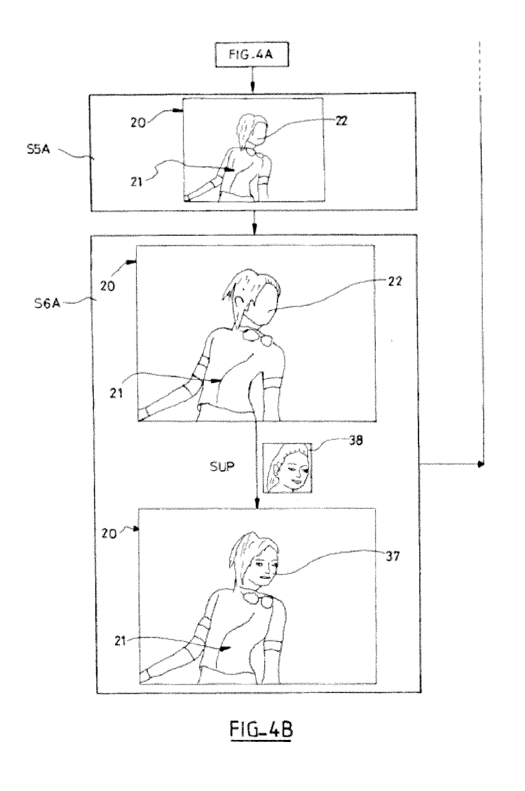

FIGS. 4A and 4B are a functional diagram illustrating one embodiment of the inventive method for the real-time cropping of a user's head recorded in a video sequence. In this embodiment, the area of the avatar's head 22 corresponding to the face is encoded in a specific way in the three-dimensional avatar head model. It may, for example, be the absence of corresponding pixels or transparent pixels.

During a first step S1A, at a given moment an image 31 is extracted EXTR from the user's video sequence 30.

During a second step S2A, a head tracker function HTFunc is applied to the extracted image 31. The head tracker function makes it possible to determine the orientation O of the user's head. It uses the noteworthy position of certain points or areas of the face 32, for example the eyes, eyebrows, nose, cheeks, and chin. Such a head tracker function may be implemented by the software application “faceAPI” sold by the company Seeing Machines.

During a third step S3A, the virtual or mixed reality environment 20 in which the avatar evolves 21 is calculated and a three-dimensional avatar head 33 is oriented ORI in a manner roughly identical to that of the extracted image's head based on the determined orientation O. The result is a three-dimensional avatar head 34A whose orientation is complies with the image of the extracted head 31. This step uses a standard rotation algorithm.

During a fourth step S4A, the image 31 extracted from the video sequence is positioned POSI and scaled ECH like the three-dimensional avatar head 34A in the virtual or mixed reality environment 20. The result is an alignment of the image extracted from the video sequence 38 and the avatar's head in the virtual or mixed reality environment 20. This step uses standard translation functions, with the translations taking into account noteworthy points or areas of the face, such as eyes, eyebrows, nose, cheeks, and/or chin as well as noteworthy points encoded for the avatar's head.

During a fifth step S5A, the image of the virtual or mixed reality environment 20 in which the avatar 21 evolves is drawn, taking care not to draw the pixels that are located outside the area of the avatar's head 22 that corresponds to the oriented face, as these pixels are easily identifiable thanks to the specific coding of the area of the avatar's head 22 that corresponds to the face and by simple projection.

During a sixth step S6A, the image of the virtual or mixed reality environment 20 and the image extracted from the video sequence comprising the user's translated and scaled head 38 are superimposed SUP. Alternatively, the pixels of the image extracted from the video sequence comprising the user's translated and scaled head 38 which are behind the area of the avatar's head 22 that corresponds the oriented face are integrated into the virtual image at the depth of the deepest pixels in the avatar's oriented face.

This way, the avatar features, within the virtual environment or mixed reality environment, the actual face of the user in front of his or her multimedia device, at roughly the same given moment. According to this embodiment, like the image of the virtual or mixed reality environment 20 that comprises the avatar's cropped face is superimposed onto the image of the user's translated and scaled head 38, the avatar's elements, for example its hair, are visible and cover the user's image.

The three-dimensional avatar head 33 is taken from a three-dimensional digital model. It is fast and simple to calculate, regardless of the orientation of the three-dimensional avatar head for standard multimedia devices. The same holds true for projecting it onto a plane. Thus, the sequence as a whole gives a quality result, even with a standard processor.

The sequence of steps S1 to S6 or S1A to S6A may then be reiterated for later moments.

Optionally, an initialization step (not depicted) may be performed a single time prior to the implementation of sequences S1 to S6 or S1A to S6A. During the initialization step, a three-dimensional avatar head is modeled in accordance with the user's head. This step may be performed manually or automatically from an image or from multiple images of the user's head taken from different angles. This step makes it possible to accurately distinguish the silhouette of the three-dimensional avatar head that will be best suited for the inventive real-time cropping method. The adaptation of the avatar to the user's head based on photo may be carried out by means of a software application such as, for example, “FaceShop” sold by the company Abalone.

The Figures and their above descriptions illustrate the invention rather than limit it. In particular, the invention has just been described in connection with a particular example that applies to videoconferencing or online gaming. Nonetheless, it is obvious for a person skilled in the art that the invention may be extended to other online applications, and generally speaking all applications that require an avatar that reproduces the user's head in real-time, for example a game, a discussion forum, remote collaborative work between users, interaction between users to communicate via sign language, etc. It may also be extended to all applications that require the real-time display of the user's isolated face or head.

The invention has just been described with a particular example of mixing an avatar head and a user head. Nonetheless, it is obvious for a person skilled in the art that the invention may be extended to other body parts, for example any limb, or a more specific part of the face such as the mouth, etc. it also applies to animal body parts, or objects, or landscape elements, etc.

Although some Figures show different functional entities as distinct blocks, this does not in any way exclude embodiments of the invention in which a single entity performs multiple functions, or multiple entities perform a single function. Thus, the Figures must be considered as a highly schematic illustration of the invention.

The symbols of references in the claims are not in any way limiting. The verb “comprise” does not exclude the presence of other elements besides those listed in the claims. The word “a” or “an” preceding an element does not exclude the presence of a plurality of such elements.

1. A method for the real-time cropping of a real entity moving within a real environment recorded in a video sequence, the real entity being associated with a virtual entity, the method comprising:
extracting from the video sequence an image comprising the recorded real entity,
determining a scale and/or an orientation of the real entity from the image comprising the recorded real entity,
transforming by scaling, orienting, and positioning in a roughly identical manner the virtual entity and the recorded real entity, and
substituting the virtual entity with a cropped image of the real entity, the cropped image of the real entity being an area of the image comprising the recorded real entity bounded by a contour of the virtual entity.

2. A cropping method according to claim 1, wherein the real entity is a body part of the user, and a virtual entity is the corresponding body part of an avatar intended to reproduce an appearance of the user's body part, the method comprising:
extracting from the video sequence an image comprising the user's recorded body part,
determining an orientation and a scale of the user's body part in the image comprising the user's recorded body part
orienting and scaling the avatar's body part in a manner roughly identical to that of the user's body part, and
using a contour of the avatar's body part to form a cropped image of the image comprising the user's recorded body part, the cropped image being limited to an area of the image comprising the user's recorded body part contained within the contour.

3. A cropping method according to claim 2, wherein the method further comprises merging the body part of the avatar with the cropped image.

4. A cropping method according to claim 1, wherein the real entity is a body part of the user, and a virtual entity is the corresponding body part of an avatar intended to reproduce an appearance of the user's body part, the method comprising:
extracting from the video sequence an image the user's recorded body part,
determining an orientation of the user's body part from the image comprising the user's body part,
orienting the avatar's body part in a manner roughly identical to that of the image comprising the user's recorded body part,
translating and scaling the image comprising the user's recorded body part in order to align it with the corresponding oriented body part of the avatar,
drawing an image of the virtual environment in which a cropped area bounded by a contour of the avatar's oriented body part is coded by an absence of pixels or transparent pixels; and
superimposing the virtual environment's image onto the image comprising the user's translated and scaled body part.

5. The cropping method according to claim 2, wherein the determining the orientation and/or scale of the image comprising the user's recorded body part is performed by a head tracker function applied to said image.

6. The cropping method according to claim 2, wherein the orienting and scaling, extracting the contour, and merging take into account noteworthy points or areas of the avatar's or user's body part.

7. The cropping method according to claim 2, wherein the avatar's body part is a three-dimensional representation of said body part of the avatar.

8. The cropping method according to claim 2, further comprising initialization comprising modeling the three-dimensional representation of the avatar's body part in accordance with the user's body part whose appearance must be reproduced.

9. The cropping method according to claim 2, where in the body part is the head of the user or of the avatar.

10. A multimedia system comprising a processor implementing the cropping method according to claim 1.

11. A computer program product intended to be loaded within a memory of a multimedia system, the computer program product comprising portions of software code implementing the cropping method according to claim 1 whenever the program is run by a processor of the multimedia system.
